(19) United States
(12) Patent Application Publication
(10) Pub. No.: US 2023/0234308 A1
(43) Pub. Date: Jul. 27, 2023

(54) METHOD FOR PROVIDING BLANKS FROM A FIBRE WEB

(71) Applicant: GFM GmbH, Steyr (AT)

(72) Inventor: Harald Dietachmayr, Sierning (AT)

(73) Assignee: GFM GmbH, Steyr (AT)

(21) Appl. No.: 17/925,035

(22) PCT Filed: May 12, 2021
(86) PCT No.: PCT/AT2021/060168

§ 371 Date: Nov. 14, 2022

(30) Foreign Application Priority Data
Aug. 7, 2020 (AT) A50587/2020

(51) Int. Cl. B29C 70/54; B65G 61/00; B29C 70/30

(52) U.S. Cl. CPC B29C 70/543; B65G 61/00; B29C 70/30

(57) ABSTRACT

The invention relates to a method for providing blanks (Z) from a fibre web (1) in a sequence predefined for constructing a workpiece from said blanks (Z) layer-by-layer, wherein the blanks (Z), which each belong to a removal region (E) of the fibre web (1), are removed from the removal regions (E) and deposited, per removal region (E), in at least one deposit element (A) and then removed from the deposit elements (A) in the sequence predefined for constructing the workpiece layer-by-layer. In order to create advantageous sorting conditions, according to the invention the blanks (Z) that are removed individually from the removal regions (E) are stacked on top of one another in the deposit elements (A) in each case in a sequence that is the reverse of their layering sequence in the workpiece.

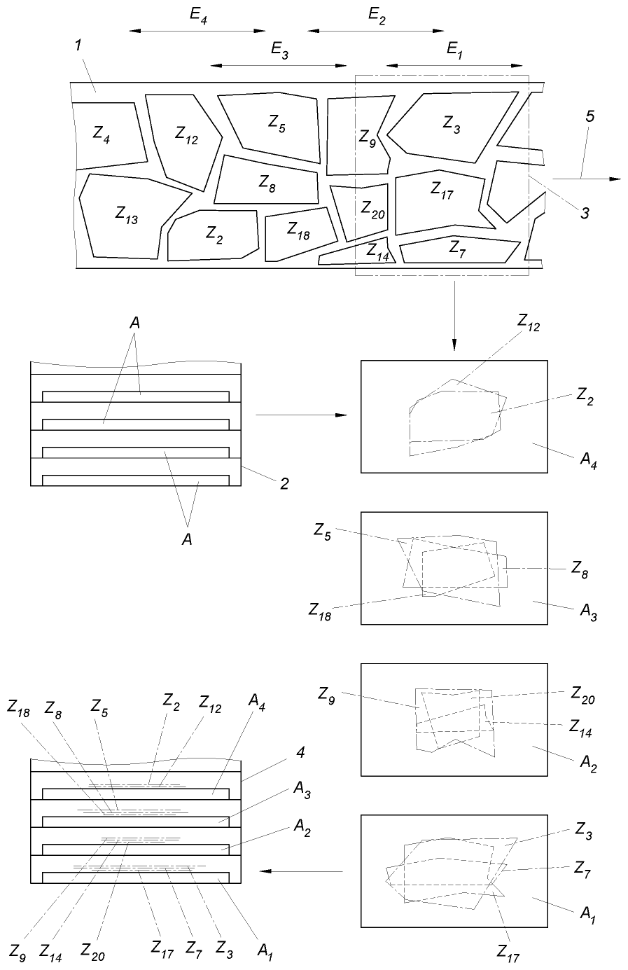

### TECHNICAL FIELD

The system described herein relates to providing blanks from a fibre web in a sequence predefined for a layer-by-layer construction of a workpiece from the blanks.

### BACKGROUND

Complex workpieces can be produced from appropriately formed, preferably pre-impregnated or thermoplastic fibre webs by inserting corresponding blanks from such fibre webs into moulds and, depending on the design, optionally curing the blanks under pressure. The layer-by-layer construction of the workpiece from individual different blanks requires the provision of these blanks in a sequence determined by the layer-by-layer construction of the workpiece to be produced. However, the sequence determined by the layer-by-layer construction may not be taken into account when distributing the blanks over the surface of the fibre web in order to minimize an amount of waste. This means that the blanks, which are to be available in a sequence determined by the layer-by-layer construction of the workpiece, are distributed in a disorderly manner over the fibre web surface with regard to the desired order (DE 20 2007 006 528 U1). The individual blanks are therefore lifted out of the fibre web with the aid of appropriate handling devices and either temporarily stored on at least one deposit table or directly fed to a lay-up station to form a shaped body. Irrespective of whether the blanks required for building up the shaped body are fed directly to the lay-up station or are first deposited on at least one deposit table next to each other or in stacks, the blanks must be sorted according to the layer-by-layer construction of the shaped body to be formed, which in the case of workpieces consisting of a large number of blanks requires a time-consuming sorting process for the blanks.

In order to automate the sorting process, it has already been proposed (EP 0 511 937 A1) to jointly lift the blanks from individual removal regions in the predetermined distribution layer out of the fibre web, which blanks are not distributed in a layering sequence corresponding to the layering sequence in the workpiece to be produced, and to deposit the blanks in the resulting distribution layer in deposit elements, in order to then store the deposit elements in an intermediate store. To insert the blanks into the mould for the production of the workpieces, the corresponding deposit elements are removed from the intermediate storage and fed to a turning device in order to be able to insert the blanks, which have been deposited on the deposit element with an impregnated side facing upwards, into the mould with the impregnation side facing downwards. For this purpose, the blanks are lifted from the deposit element by the turning device in the distribution layer and turned through 180° about a horizontal axis in order to then be inserted individually into the mould with the aid of a laying device in the sequence of the layer structure of the workpiece to be produced. Since the distribution position of the blanks in the removal regions and the order of the blanks within the layering sequence of the workpiece to be produced are known and these parameters do not change during blank removal and during further conveying of the blanks by means of the deposit elements and the turning device, the individual blanks can be detected precisely with respect to position by the laying device and inserted into the mould in the sequence specified by the layering sequence in the workpiece. However, a particular disadvantage of this mechanism is that due to the mandatory maintenance of the distribution position after the removal of the blanks from the respective removal region of the fibre web, deposit elements with corresponding depositing surfaces must be provided. In addition, it must be possible to provide all blanks required for the construction of at least one section of the workpiece having several layers from a deposit element in a corresponding sequence, so that despite the possible unordered distribution of the blanks over a removal region of the fibre web, a possibly considerable amount of waste must be accepted. These known sorting systems are therefore essentially only suitable for workpieces whose layers can be provided by blanks from a single removal region, which considerably limits the area of application.

In the case of workpieces that consist of comparatively few layers, the blanks for the individual layers can be deposited together in deposit elements (WO 2012/104174 A1) in order to then be able to remove the blanks from the individual storage elements by at least one robot in a sequence corresponding to the layer structure of the workpieces to be produced and insert the blanks into the mould. Since matching blanks for a large number of workpieces are to be provided next to each other and aligned on the deposit elements, the deposit elements again require a considerable amount of space to accommodate the individual blanks. Apart from that, such sorting devices are only suitable for the production of workpieces with a comparatively small number of layers.

### SUMMARY OF THE INVENTION

The system described herein provides a system where a plurality of blanks, which are distributed in a fibre web independently of a removal sequence, can also be removed from the fibre web without time-consuming searching in a sequence which enables the blanks to be passed on advantageously in a predetermined sequence determined by the workpiece structure.

The system described herein provides a mechanism in which blanks that are removed individually from the removal regions are stacked on top of each other in the deposit elements in each case in a sequence that is the reverse of the layering sequence of the blanks in the workpiece.

Since the blanks cut out of the fibre web are removed from a removal region irrespective of whether the blanks in the removal region form a sequence determined by the workpiece structure, the blanks required for the production of a workpiece are progressively released from the fibre web from removal region to removal region, making a time-consuming search of the fibre web for blanks for specific layers in the workpiece unnecessary.

Despite the removal of the blanks from removal regions in which the blanks are not present in a sequence corresponding to the workpiece structure, a pre-sorting can be carried out which allows a subsequent transfer in a sequence determined by the workpiece structure. For this purpose, the individual blanks, the sequence of which is known within the workpiece structure, are stacked one on top of each other in at least one deposit element in each removal region in a sequence which corresponds to a reverse sequence to the respective layering sequence in the workpiece. This means that the blanks in each deposit element are stacked on top of each other in a descending sequence of an order when the workpiece is built up from the individual blanks in an ascending sequence of order. The order of the individual blanks is determined by the layer in the workpiece structure predefined for each blank, so that the blank for an i^{th} layer has an i^{th} order.

If, for example, a removal region includes the blanks for the third, eighth and nineteenth layers of the workpiece, i.e. if the blanks from the removal region have an order three, eight and nineteen, the blanks are deposited in a stack in a deposit element with a descending order relative to the ascending order of the associated layers in the workpiece, so that the blank for the nineteenth layer is followed by the blank for the eighth layer and then by the blank for the third layer in the stack. Consequently, the blanks can be removed one after the other from the stack of the respective deposit element according to the ascending order of the layers of the workpiece to be produced. Since all blanks required for the workpiece structure are stored in this way, sorted in deposit elements from the individual removal regions, the blanks can be removed from the blank stacks of the individual deposit elements in an order corresponding to the workpiece structure. The next blank required in the layering sequence after the insertion of a blank into the mould for the layer-by-layer production of the workpiece always forms the top layer of a stack of the deposit elements, so that the blanks can be removed from the stacks of deposit elements in a sequence required for the layer structure of the workpiece. The minimum number of deposit elements depends on the number of removal regions.

If the removal regions include a larger number of blanks, the removal of the individual blanks can be accelerated by the provision of at least two grippers for the blanks, because the grippers can deposit the blanks gripped by the grippers independently of one another in separate deposit elements to form stacks, in each case in a descending or ascending order within the stack which is required for the layer-by-layer structure of the workpiece and depends on the ascending or descending order of the layers in the workpiece.

However, the individual blanks are not only be removed from the stacks of deposit elements in an ascending or descending order, but also transferred to the mould for the workpiece in an aligned position. For this purpose, the individual blanks may be placed on top of each other in a predetermined position in stacks in the deposit elements, so that the spatial orientation of the individual blanks placed in alignment in the storage elements is determined on the basis of the position of the deposit elements and the blanks can be removed from the deposit elements without having to determine an orientation of the blanks again.

The orientation of the blanks in relation to the deposit elements does not have to correspond to the original orientation of the blanks within the fibre web. Preferably, an orientation is chosen that allows a space-saving stacking of the blanks on the storage elements.

### BRIEF DESCRIPTION OF THE DRAWINGS

The system described herein is explained in more detail with reference to the sole FIGURE, which shows a schematic block diagram of a sorting device for carrying out a sorting method.

### DESCRIPTION OF VARIOUS EMBODIMENTS

In order to produce a workpiece made up of layers of a fibrous material, blanks Zᵢ corresponding to the individual layers are cut out of, for example, a pre-impregnated fibre web 1 and inserted in a sequence corresponding to the layering sequence into a mould provided for the production of the workpiece. In order to be able to use the fibre web 1 optimally with minimised waste, the individual blanks Zᵢ are arranged according to sizes and geometric outline shapes of the blanks Zᵢ distributed over the fibre web 1 independently of layer positions of the blanks Zᵢ in the workpiece structure. An order i of the blanks Zᵢ is determined by a sequence of the individual layers of the workpiece, where i stands for the number series 1 to n, where n is a total number of blanks used for the workpiece structure.

In order to ensure that the entire fibre web 1 does not have to be searched for the provision of the individual blanks Zᵢ in a sequence corresponding to the layer structure of the workpiece to be produced and in order to be able to remove the blanks Zᵢ in an order which is reversed in relation to the layering sequence in the workpiece to be produced, the blanks Zᵢ are removed one after the other from individual removal regions Eⱼ and are deposited per removal region Eⱼ in at least one deposit element Aⱼ in stacked form, in each case in an ascending or descending order which corresponds to the descending or ascending order of the layers in the structure of the workpiece to be produced.

As can be seen from the drawing, in order to remove the blanks Z₃, Z₁₇and Z₇, which form the subsequent layers No. 3, 17 and 7, from a removal region E₁, a deposit element Al is first provided for stacking the blanks Zᵢ from a supply store 2. The blanks Z₃, Z₁₇ and Z₇, which are provided with a corresponding identifier for an order of the blanks Z₃, Z₁₇ and Z₇, are released from the fibre web 1 in an order corresponding to a descending order of the blanks Z₃, Z₁₇ and Z₇ from the removal region E₁ with the aid of a removal device 3 indicated by a dot-dash line on the basis of the ascending order of the layering sequence of the workpiece to be produced, so that first of all the blank Z₁₇ is removed from the fibre web 1 in an orientation predetermined by a position in the fibre web 1 and is deposited on the deposit element A₁, namely in a specific orientation with respect to the deposit element A₁, which does not have to correspond to the original orientation and is preferably selected in such a way that the space conditions on the deposit element can be used advantageously for stacking the blanks Zᵢ. After the blank Z₁₇ has been aligned, the blank Z₇ and finally the blank Z₃ are each placed on top of each other in a stack on top of the blank Z₁₇, aligned with respect to the deposit element A₁. When all the blanks Zᵢ have been removed from the removal region E₁, the loaded deposit element A₁ is conveyed to a store 4 from which the individual deposit elements Aⱼ can be made available for the removal of their blanks Zᵢ. Although the store 4 is shown as a separate storage unit from the supply store 2 for reasons of clarity, in practice only one storage unit will often be provided which takes over the tasks of both the supply store 2 and the store 4.

To remove the blanks Zᵢ from a subsequent removal region E₂, the fibre web 1 is conveyed further in the direction of an arrow 5 accordingly in order to align the removal region E₂ with respect to the removal device 3. The removal process is repeated, wherein the blanks Z₂₀, Z₁₄ and Z₉ are deposited one after the other on an empty deposit element A₂ from the supply store 2 to form a stack before the deposit element A₂ is placed in the store 4. In order to ensure better stackability, the blank Z₉ may be placed on the deposit element A₂ rotated by 90° in relation to the orientation in the fibre web 1.

After a conveying step in the direction of the arrow 5, the blanks Zᵢ from the removal region E₃ are placed on top of each other in a stack in a descending order on a deposit element A₃ in an analogous manner, wherein the blank Z₁₈ is again deposited on the deposit element A₃ in an aligned manner and then the blanks Z₈ and Z₅ are stacked one on top of the other on the blank Z₁₈ in order to have this stack available for removing the blanks Zᵢ after the deposit element A₃ has been placed in the store 4.

The blanks Z₁₂ and Z₂ of the removal region E₄ are removed from the fibre web 1 in the same way and deposited aligned in a stack in a deposit element A₄ before the deposit element A₄ is transferred to the store 4. The blank Z₁₂ may be turned before being deposited in order to improve stackability on the deposit element A₄.

After the deposit element A₄ and all other deposit elements Aⱼ, which accommodate the blanks Zᵢ required for the production of a workpiece from the removal regions Eⱼ, have been stored in the store 4, the blanks Zᵢ stacked in the storage elements Aj can be removed one after the other from the storage elements Aj in a continuous sequence corresponding to the ascending order of the layers in the workpiece and placed in the mould for the production of the workpiece.

For the sake of a clear representation, the deposit elements Aⱼ loaded with the associated blanks Zᵢ are shown in the drawing one after the other corresponding to the removal regions although the deposit elements Aⱼ may be transferred from the associated removal region Eⱼ to the store 4 after being loaded with the blanks Zᵢ before the blanks Zᵢ of the subsequent removal region Eⱼ₊₁ are stacked on a new deposit element Aⱼ₊₁. In the store 4, the stored, loaded deposit elements A1-A4 are indicated with the blank stacks, wherein the deposit elements Aⱼ do not have to be stored in the store 4 in the order of the removal regions. It is only necessary to know in which storage locations the individual deposit elements Aⱼ are located.

In order to produce a workpiece from the blanks Z₁-Zₙ, the blanks Z₁-Zₙ are placed in an appropriate mould starting with Z₁ in ascending order, so that the blank Z₁ forms a bottom layer and the blank Zₙ forms a top layer of the workpiece to be produced. This means that the blank Z₁, which forms the top layer in a deposit element Aⱼ, is first removed from this deposit element before the blank Z₂ can be removed from another deposit element A if the blank Z₂ is not in the same deposit element Aⱼ as the blank Z₁. According to the exemplary embodiment shown, the blank Z₂ is therefore taken from the deposit element A₄. The individual blanks Zᵢ can thus be removed in ascending order from the individual deposit elements Aⱼ without rearranging the blanks Z₁-Zₙ in the individual deposit elements Aⱼ.

If the blanks Zᵢ are deposited in the individual removal regions Eⱼ not only in one deposit element Aⱼ, but in two or more deposit elements Aⱼₖ, the sorting process can be accelerated considerably because the deposit elements Aⱼₖ available for each removal region Eⱼ can be loaded with the blanks Zᵢ independently of each other via separate grippers, again in a descending order for each deposit element Aⱼₖ.

It should also be noted that the removal regions E of the fibre web 1 do not have to contain only blanks Zᵢ for one workpiece. If blanks for several workpieces are provided in a removal region, which can lead to a further minimisation of waste, separate deposit elements A may be provided for the blanks Z of separate workpieces in order to be able to provide a set of deposit elements A for each workpiece, the stacks of which contain all blanks required for the construction of the workpiece in a corresponding order.

1. A method for providing blanks from a fibre web in a sequence that is predefined for a layer-by-layer construction of a workpiece from the blanks, comprising:
removing the blanks from each removal region of a plurality of removal regions of the fibre web;
depositing each of the blanks, per removal region, in at least one of a plurality of deposit elements;
removing individually the blanks from the deposit elements in a sequence predefined for the layer-by-layer construction of the workpiece, wherein the blanks that are removed individually from the removal regions are stacked on top of each other in the deposit elements in a sequence that is a reverse of a layering sequence of the blanks in the workpiece.

2. The method according to claim 1, wherein the blanks for the workpiece are stacked in a plurality of deposit elements and are removed individually from the deposit elements in a sequence predefined for the layer-by-layer construction of the workpiece and are introduced into a mould for producing the workpiece.

3. The method according to claim 1, wherein the blanks are removed from the removal regions of the fibre web with the aid of at least two grippers and are stacked on top of each other in at least two deposit elements per removal region.

4. The method according to claim 1, wherein the blanks are stacked on top of each other in a predefined position in the deposit elements.

5. The method according to claim 2, wherein the blanks are removed from the removal regions of the fibre web with the aid of at least two grippers and are stacked on top of each other in at least two deposit elements per removal region.

6. The method according to claim 2, wherein the blanks are stacked on top of each other in a predefined position in the deposit elements.

7. The method according to claim 3, wherein the blanks are stacked on top of each other in a predefined position in the deposit elements.

8. The method according to claim 5, wherein the blanks are stacked on top of each other in a predefined position in the deposit elements.
